(19) United States
(12) Patent Application Publication
(10) Pub. No.: US 2015/0280420 A1
(43) Pub. Date: Oct. 1, 2015

(54) SURGE SUPPRESSION DEVICE

(71) Applicant: Xiaomao MAO, Foshan (CN)

(72) Inventor: Xiaomao MAO, Foshan (CN)

(21) Appl. No.: 14/447,417

(22) Filed: Jul. 30, 2014

(30) Foreign Application Priority Data
Mar. 28, 2014 (CN) 201420145977.8

(51) Int. Cl. H02H 5/04; H02H 3/20

(52) U.S. Cl. CPC H02H 5/047; H02H 3/20

(57) ABSTRACT

A surge suppression device is disclosed comprising a voltage sensitive element, heat sensitive materials, a second terminal, and a conductive metal plate, which are substantively connected in parallel with respect to each other, such that a laminated structure is formed. The laminated structure maximizes the contact areas between theses elements, such that a conductive metal plate disposed between the voltage sensitive element and the contact portion of the second terminal is able to absorb and transfer, to the greatest extent, the heat generated by the voltage sensitive element due to over-voltage applied thereon, to the first heat sensitive material, so that an improved sensitivity is achieved.

### CROSS-REFERENCE TO RELATED APPLICATION

This application claims priority to Chinese Utility Model Application Number 201420145977.8, filed on Mar. 28, 2014, the entire disclosure of which is hereby incorporated by reference.

### FIELD

The invention disclosed relates to a surge suppression device for circuit protection and, in particular, to a surge suppressor with arc extinguishing effects.

### BACKGROUND

A surge suppression device is an electronic device used for prevent various electronic equipments, instruments, and communication circuits from damage from surge current or over-voltage caused by sudden interference external to electrical circuits.

A surge suppression device typically comprises one or more metal-oxide varistors (MOVs) connected in parallel between a service power line and a ground or neutral line, or between a neutral line and a ground line, for absorbing and dissipating the energy related to the over-voltage. MOVs are non-linear, electronic devices that are frequently subjected to various external stresses during operation, such as temperature stresses or transient voltage surge stresses.

When subject to over-voltage, i.e., voltage higher than its rating value, MOV degrades, causing increase of leakage current and in most cases overheating, and possibly thermal breakdown short circuit. The heating of MOV elevates the temperature of the surge suppression device containing the MOV. When the temperature reaches the ignition temperature of combustible materials surrounding the MOV, such as epoxy coatings or plastic housing, it may cause fire.

In order to reduce the risk of catching fire due to surge suppression devices, a thermal protector for MOV was proposed. The thermal protector of this kind is able to separate a failed MOV from a power supply circuit under certain circumstances, therefore to some extent preventing the surge suppression devices from catching fire. However, the disadvantages reside in that, if the MOV is already suffered from breakdown short circuit before the open of the connection point of the thermal protector, an electric arc will be generated between the gap as formed after the disconnection of the thermal protector. The arc current, in this situation, equals to the short-circuit current of the power supply system. An ordinary thermal protector is possibly not able to distinguish such an arc. In another aspect, even though the MOV is not suffered from breakdown short circuit before the open of the connection point of the thermal protector, an electric arc is still possibly generated due to existence of relatively high voltage and/or relatively small gap distance between the electrode of the thermal protector contacting the MOV and the electrode on the MOV surface. Therefore, the fault current originating from the power supply system may be maintained and the risk that the surge suppression device may catch fire still exists.

Therefore, some surge suppression devices are incorporated with an arc extinguishing mechanism, which overcome the disadvantage that conventional surge suppression devices having a thermal protector can only block small fault current. However, those surge suppression devices suffer from shortcomings such as insufficient sensitivity, low arc-extinguishing speed, over-sized dimension, and/or limited applications.

### SUMMARY

An object of the invention is to provide a surge suppression device which reacts to the heating of a voltage sensitive element in a more accurate and timely manner, so as to reduce the risk of catching fire.

Another object of the invention is to provide a surge suppression device which actuates the action of arc distinguishing much faster after the failure of the surge suppression device.

Yet another object of the invention is to provide a surge suppression device which is able to quickly distinguish any electric arc possibly generated after the failure of the surge suppression device.

Still another object of the invention is to provide a surge suppression device which has better structural stability and minimize the possibility of arc generation by its structure features.

These and other objects and advantages of the invention are achieved by the solutions described herein after. It is noted that the objects or advantages are not necessarily achieved at the same time, but instead, can be achieved independently from each other.

In order to achieve one or more objects identified above, in one aspect, a surge suppression device is provided, which comprises

a voltage sensitive element having a predetermined voltage rating, said voltage sensitive element increasing in temperature as voltage applied to the voltage sensitive element exceeds said voltage rating;

a first terminal having one end electrically connected to a first surface of said voltage sensitive element;

a second terminal comprising an arm portion and a contact portion, the contact portion being electrically connected to a second surface of the voltage sensitive element, and the second terminal being biased away from the voltage sensitive element;

a non-conductive barrier biased to move from a first position in which said non-conductive barrier allows electrical contact between the second terminal and the voltage sensitive element, to a second position in which the second terminal is not in contact with the voltage sensitive element and the non-conductive barrier is disposed between said second terminal and the voltage sensitive element, wherein

in the first position, a conductive metal plate is disposed between the contact portion and the voltage sensitive element, the contact portion being electrically connected to the conductive metal plate through a first heat sensitive material, the conductive metal plate being electrically connected to the voltage sensitive element through a second heat sensitive material, and wherein

the contact portion, the first heat sensitive material, the conductive metal plate, the second heat sensitive material and the voltage sensitive element are connected substantively in parallel with respect to each other.

In one embodiment, the conductive metal plate has a surface area not less than that of the contact portion. For example, the conductive metal plate has a surface area equal or larger than that of the contact portion. Preferably, the conductive metal plate occupies from about 10% to about 100%, or about 20% to about 100%, or about 30% to about 100%, or about 40% to about 100%, or about 50% to about 100%, or about 60% to about 100%, or about 70% to about 100%, or about 80% to about 100%, or about 90% to about 100%, preferably about 50% to about 90%, about 60% to about 90%, about 70% to about 90%, about 80% to about 90%, more preferably about 50% to about 80%, about 60% to about 80%, about 70% to about 80%, of the surface area of the second surface of the voltage sensitive element.

In one embodiment, the conductive metal plate is formed of copper or plated copper. The copper may be, for example, red copper or brass. The plated copper for example may be tin-plated or silver-plated red copper or brass.

In another embodiment, for example, the first heat sensitive material may be a low-temperature soldering material and the second heat sensitive material may be a high-temperature soldering material, and the first and/or the second heat sensitive materials are in conductive solid form and able to melt at a predetermined softening temperature. The first heat sensitive material has a softening temperature not higher than that of the second heat sensitive material. In one embodiment, the first heat sensitive material has a softening temperature less than that of the second sensitive material. In another embodiment, the first heat sensitive material has a softening temperature equal to that of the second sensitive material. Preferably, the first and/or second heat sensitive material is a solder metal comprised of a fusible alloy.

In one embodiment, the non-conductive barrier has an edge with reduced thickness. For example, the non-conductive barrier has a wedge-shaped edge. In another embodiment, in the first position, the edge of the non-conductive barrier is abutted against the first heat sensitive material and/or the contact portion.

In embodiment of the invention, the voltage sensitive element is preferably a metal oxide varistor (MOV), for example, a MOV bare disc having a silver or copper outer layer.

In one embodiment, the non-conductive barrier is biased toward the second position by an elastic element. In one embodiment, the non-conductive barrier has a stopper element extending from a surface of the barrier, for holding the elastic element. Preferably, the stopper element has a guiding portion for receiving the elastic element. The elastic element is preferably a spring.

In one embodiment, the arm portion has a cantilever with the free end of the cantilever oriented toward the non-conductive barrier and applying a force to the non-conductive barrier.

In one embodiment, the cantilever is formed by cutting a portion of the arm portion of the second terminal, and the free end of the cantilever is in contact with the non-conductive barrier, the opposing end is integral with the arm portion of the second terminal.

In one embodiment, the surge suppression device further comprises a seat on which the one end of the first terminal, the arm portion of the second terminal, the non-conductive barrier and the voltage sensitive element are mounted. In one embodiment, the seat comprises a pivot mount to which a pivot of the non-conductive barrier is mounted, such that the non-conductive barrier can rotate about the pivot.

In the surge suppression device provided by the present invention, the contact portion of the second terminal, the first heat sensitive material, the conductive metal plate, and the voltage sensitive element are substantively connected in parallel with respect to each other, such that a laminated structure is formed. The laminated structure maximizes the contact areas between theses elements, such that the conductive metal plate disposed between the voltage sensitive element and the contact portion of the second terminal is able to absorb and transfer, to the greatest extent, the heat generated by the voltage sensitive element due to over-voltage applied thereon, to the first heat sensitive material, so that an improved sensitivity is achieved.

In addition, when the conductive metal plate has a surface area greater than that of the contact portion, for example, accounting for most of a MOV surface, the conductive metal plate will absorb most of the heat generated by the MOV and transfer the heat to the first heat sensitive material, such that it is more accurate to sense and respond to the heating of the MOV.

Typically, a silver layer having a thickness of between 30 and 50 μm is provided on a MOV surface. If the conductive metal plate is absent, the contact portion of the second terminal will be directly soldered to the silver layer. In this case, when large current occurs in the circuit, the heat generated will be concentrated on the portion of the silver layer where the contact portion locates. The silver layer therefore will be extremely prone to damage, causing damage to the MOV. When the conductive metal plate is present between the contact portion and the MOV silver layer and when large current occurs in the circuit, the conductive metal plate will disperse the stress generated by the large current and in the meantime distributed the heat as generated due to the large current across the metal plate, so as to avoid any heat concentration on a particular point or small area, so that the MOV is protected.

Moreover, since the edge of the non-conductive barrier is biased against the first heat sensitive element and/or the contact portion, when the second terminal is separated from the voltage sensitive element (specifically, from the conductive metal plate), the non-conductive barrier will reach the gap as formed by the separation and locate between the second terminal and the voltage sensitive element in minimum time, such that the action of arc extinguishing can be actuated faster to extinguish any possible electric arc.

Further, the cantilever in contact with the non-conductive barrier as provided to the second terminal reduces the stress applied to the first heat sensitive material and/or the contact portion by the non-conductive barrier, which improves the structural stability of the surge suppression device.

Finally, the pivot mount provided on the seat enables to non-conductive barrier to rotate about the pivot, such that the barrier moves from the first position to the second position without monolithic translation, but through a small-angle rotation. In this way, the time taken for the movement is reduced to achieve faster arc distinguishing.

### BRIEF DESCRIPTION TO THE DRAWINGS

The invention will be described in various embodiments in reference to the accompanied drawings, in which the features shown are illustrative only and should not be interpreted as limiting to the scope of the present invention.

FIG. 1 is a surge suppression device in effect according to one embodiment of the present invention.

FIG. 2 is an exploded view of a barrier of the surge suppression device as shown in FIG. 1.

FIG. 3 is an exploded view of a seat of the surge suppression device as shown in FIG. 1.

FIG. 4 shows the top view of the surge suppression device as shown in FIG. 1.

FIG. 5 is a sectional view along the line B-B as shown in FIG. 4.

FIG. 6 shows another arrangement of the elements of surge suppression device.

FIG. 7 shows the surge suppression device of FIG. 1 in failed state.

FIG. 8 shows a sectional view of the failed surge suppression device as shown in FIG. 7.

FIG. 9 is a surge suppression device in effect according to another embodiment of the present invention.

FIG. 10 is a sectional view of the surge suppression device as shown in FIG. 9.

FIG. 11 shows the surge suppression device of FIG. 9 in failed state.

FIG. 12 is a sectional view of the failed surge suppression device as shown in FIG. 11.

FIG. 13 is a surge suppression device in effect according to yet another embodiment of the present invention.

### DETAILED DESCRIPTION

The present invention will be described in conjugation with embodiments and drawings. It is understood that those embodiments are provided as examples, and one or more features from one of the embodiments may be combined with one or more features from another embodiment, to form a new embodiment comprising combinations of features from different embodiments. All of the embodiments are contemplated and within the scope of the present invention. Similarly, one feature of the invention as shown in one figure may be combined with another feature of the invention shown in another figure to constitute an embodiment comprising both of the features, which is also within the scope of the present invention.

### Example 1

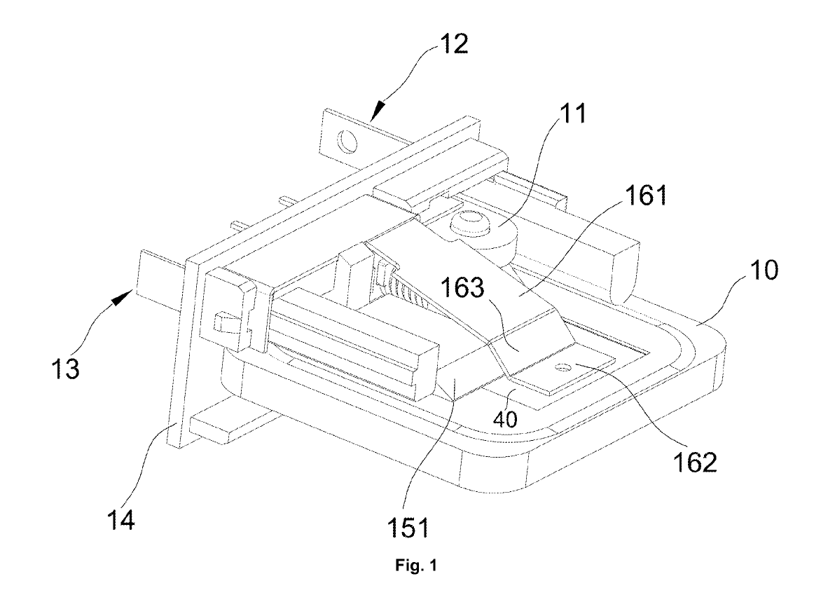

FIGS. 1 through 8 illustrate an exemplary embodiment of the invention.

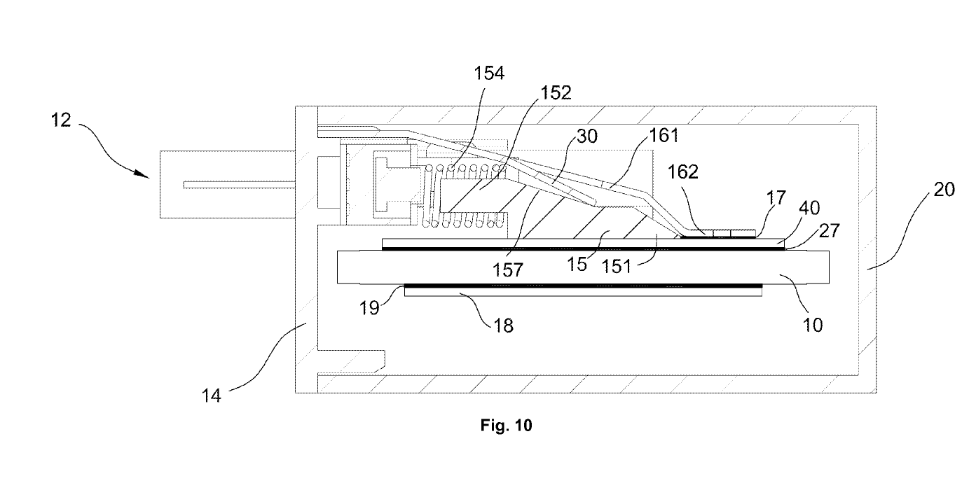

FIG. 1 shows an exemplary surge suppression device in rectangular shape. Of course, it can be of any other practical shapes as appreciated by a skilled person in the art. A housing 20 (as shown in FIGS. 10, 11 to 14) is omitted in order to show interior elements. The surge suppression device comprises a metal oxide varistor (MOV) 10 having a predetermined voltage rating. When a voltage higher the rating voltage is applied to the MOV, it will increase in temperature.

The surge suppression device further comprises a negative terminal 12 and a positive terminal 13. The terminal 12 has a contact portion 162 electrically connected to one surface of the MOV and an opposing end connectable to a ground or neutral line. The terminal 13 has one end 18 electrically connected, such as by soldering materials 19, to an opposing surface of the MOV and another end connectable to an electrical power line. The MOV can sense the voltage drop between the electrical power line and the ground or neutral line.

The terminal 12 further comprises an arm portion 161 and a bending portion 163 connecting the arm portion 161 and the contact portion 162. In other embodiments of the invention, the bending portion 163 may not exist, so that the arm portion 161 is directly connected to the contact portion 162. The existence of the bending portion 162 extends the spatial height between the arm portion 161 and the MOV, facilitating the accommodation of the non-conductive barrier 15 and its edge 151 (see below). The arm portion 161, bending portion 163 and the contact portion 162 normally form as a single piece, for example a metal plate, such that the contact portion 162 is biased away from the MOV by the intrinsic elasticity of the metal plate.

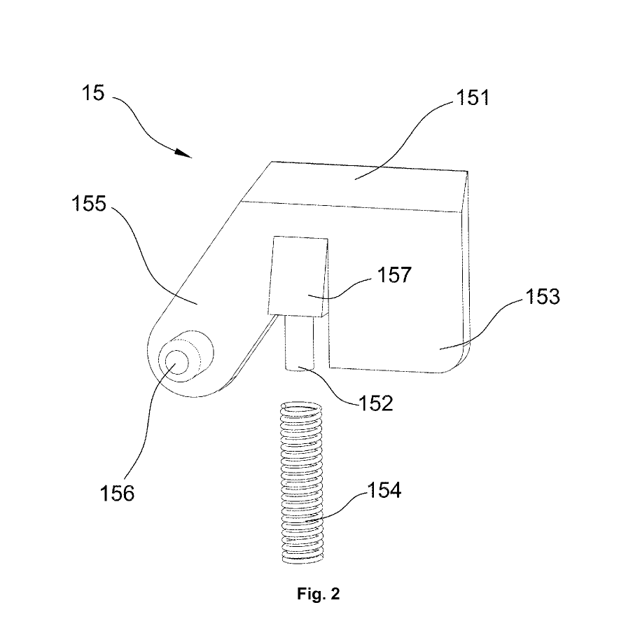

As described above, the surge suppression device comprises a non-conductive barrier 15, as can be seen from FIGS. 1 and 2. In this example, the non-conductive barrier 15 is generally a sheet and has a body 153 and an edge 151 having gradually decreased thickness. The edge 151 is substantively wedge-shaped. As shown in FIG. 2, the non-conductive barrier 15 may comprises a stopper element 157 extending from the body 153 and a spring 154. The spring 154 is received in the body 153, for example by an optional guiding portion 152, and obstructed by the stopper element 157. The non-conductive barrier 15 may also comprises an extension 155 and a pivot 156 disposed at a free end of the extension 155.

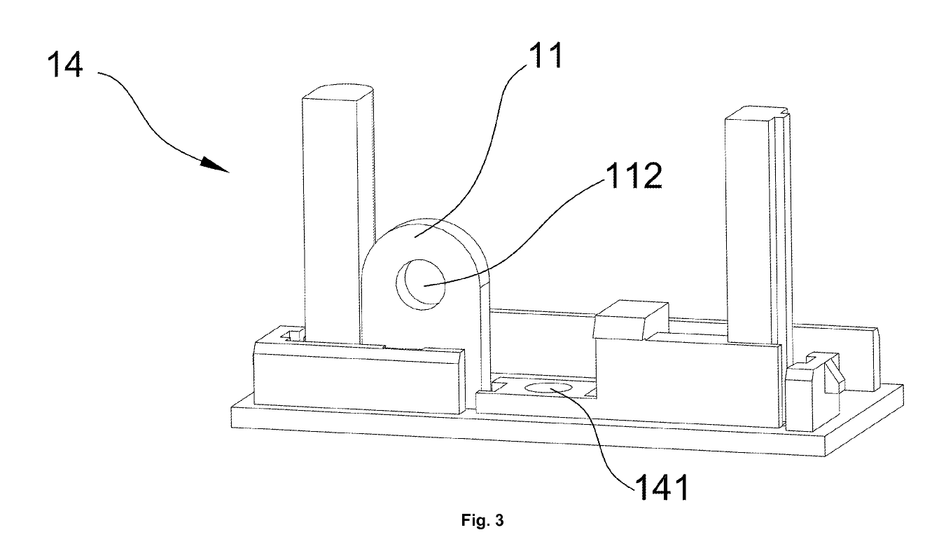

As shown in FIG. 1, terminals 12, 13, MOV 10, the barrier 15 and other elements are mounted on a seat 14. As shown in FIG. 3, the seat 14 comprises a pivot mount 11 and a pivot hole 112. The pivot 156 of the extension 155 of the barrier 15 can be received in the pivot hole 112 such that the barrier 15 can rotate about the pivot.

As shown in FIG. 3, the seat 14 may comprises an accommodation space 141 for accommodating the spring 154. In use, the spring 154 is located between the seat 14 and the stopper element 157 and in compressed state, such that the barrier 15 is biased away from the position as shown in FIG. 1.

FIGS. 2 and 3 only show an exemplary way for achieving the movement of the barrier 15. Other ways can be envisioned to achieve the biased movement of the barrier 15.

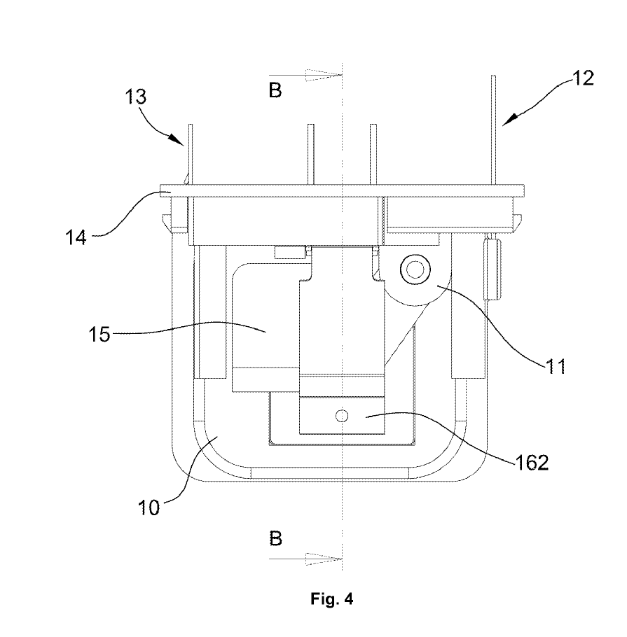

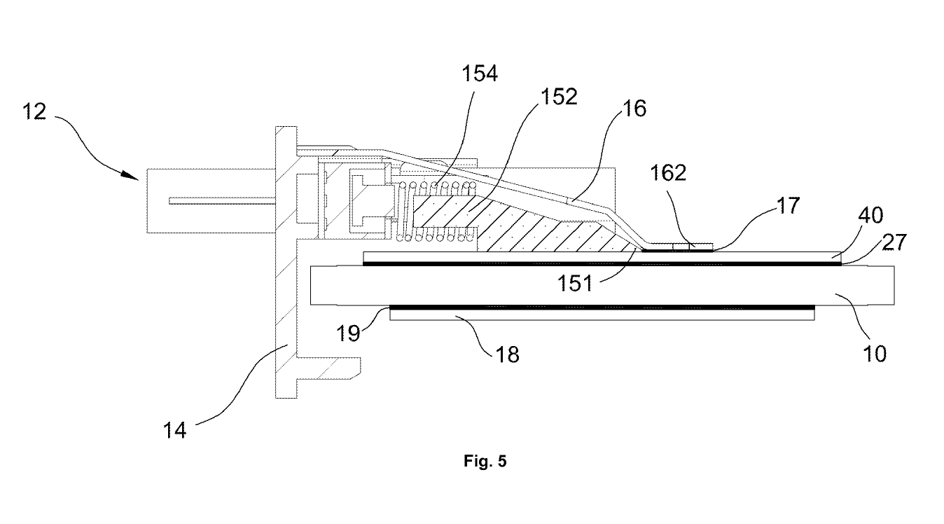

FIG. 4 shows the top view of the surge suppression device as shown in FIG. 1 and FIG. 5 shows the sectional view along line B-B shown in FIG. 4. The contact portion 162 is connected to the MOV 10 through an electrically conductive metal plate (such as a red copper plate 40) and heat sensitive materials (such as soldering materials 17, 27). In this example, the contact portion 162 is connected to the red copper plate 40 through low-temperature soldering material 17, and the red copper plate 40 is then connected to the surface of the MOV 10 through high-temperature soldering material 27.

The low-temperature soldering material 17 is for example soldering material having a melting temperature of between 90° C. and 200° C. The high-temperature soldering material 27 is for example soldering material having a melting temperature above 200° C. The soldering materials 17, 27 are commercially available on the market. As a non-limiting example, the low-temperature soldering material 17 is a solid at room temperature (25° C.) and does not melt until up to about 90° C. Alternatively, the low-temperature soldering material 17 starts to melt or soften at a temperature ranging from about 70° C. to about 140° C., preferably from about 90° C. to about 200° C.

In other examples, for example, the heat sensitive materials can be formed by metal solder comprised of a fusible alloy, or an electrically conductive polymer. The person skilled in the art can readily select proper materials for use as the sensitive materials based on the disclosure of the present invention.

In this example, the MOV 10, the contact portion 162 of the terminal 12, and the red copper plate 40 have a joint angle of about 180° C., i.e., they are substantively connected in parallel such that they have the maximum contact area there between. The red copper plate 40 disposed between the MOV 10 and the contact portion 162 is able to transfer, to the greatest extent, the heat generated by the MOV 10 due to over-voltage applied thereon, to the low-temperature soldering material 17, to improve sensitivity.

As shown in FIG. 5, the red copper plate 40 has same area with that of the high-temperature soldering material 27 (area A), and the contact portion 162 has same area with that of the low-temperature soldering material (area B), and area A is significantly larger than area B. In another aspect, the area A is less than the surface area of the MOV 10 and accounts for about 70-80% of the surface area of the MOV 10.

The areas A and B may be varied. For example, the red copper plate 40 and the high-temperature soldering material 27 may have an area only slightly larger than that of the contact portion. Alternatively, the contact portion 162 may have an area larger or less than that of the low-temperature soldering material 17. Alternatively, the red copper plate 40 may have an area larger or less than that of the high-temperature soldering material 27.

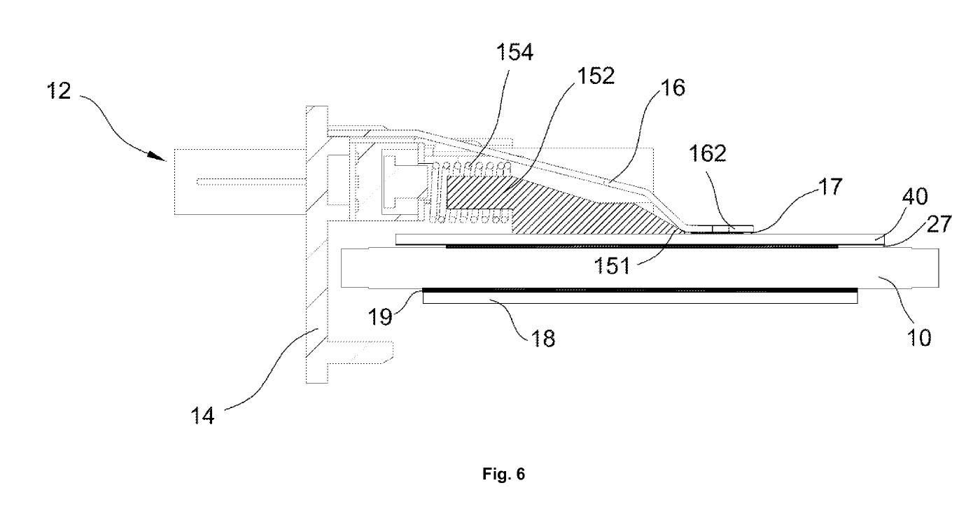

FIG. 6 shows another arrangement, wherein the low-temperature soldering material 17 has an area less than that of the contact portion 162, and the high-temperature soldering material 27 has an area less than that of the red copper plate 40. This possibly occurs during the manufacturing of the present surge suppression device.

As shown in FIG. 5, the edge 151 of the barrier 15 is abutted against the low-temperature soldering material 17 and, in the first position, the low-temperature soldering material 17 is a solid such that it can prevent the edge 151 from movement toward right direction in the figure. In other words, in the example shown in FIG. 5, the low-temperature soldering material 17 holds the barrier 15 such that the latter is not able to move and the barrier 15 does not have any other part contacting directly with any other part of the second terminal.

However, in the example as shown in FIG. 6, the low-temperature soldering material 17 does not fill full of the clearance formed between the contact portion 162 and the red copper plate 40, resulting that the edge 151 of the barrier 15 can not abut against the low-temperature soldering material 17. As a result, the low-temperature soldering material 17 is not able to obstruct the barrier. In this situation, the edge 151 will abut against the contact portion 162 and partially extend into the clearance formed between the contact portion 162 and the red copper plate 40. In this case, the contact portion 162 prevents the edge 151 from movement toward right direction in the figure. The terminal 12 has no other part contacting directly with any other part of the barrier 15.

It can be appreciated that, the low-temperature soldering material 17 has an area such that the edge 151 of the barrier 15 may contact the low-temperature soldering material 17 and the contact portion 162 of the terminal 12 simultaneously. In this case, the low-temperature soldering material 17 and the contact portion 162 jointly prevent the edge 151 from movement toward right direction in the figure.

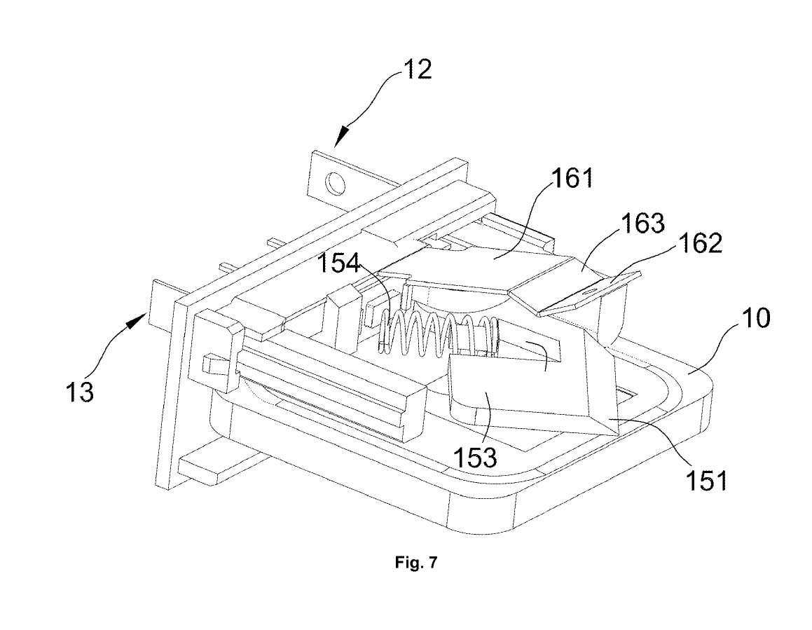

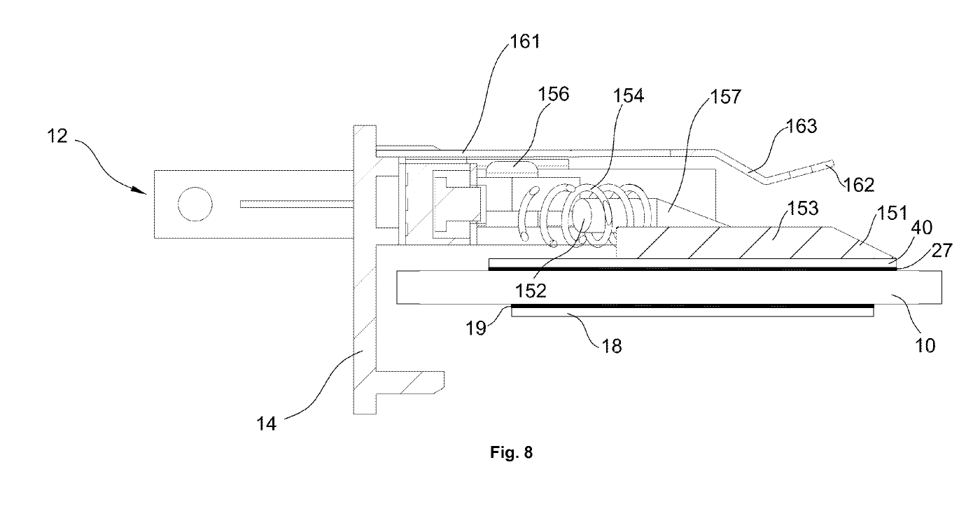

FIG. 7 shows the surge suppression device of FIG. 1 in failed state. FIG. 8 is a sectional view showing the failed device. When the MOV is subject to voltage higher than the voltage rating thereof, it will increase in temperature, causing the heating of the low-temperature soldering material 17. When the temperature reaches the melting/softening temperature of the low-temperature soldering material, the soldering material will gradually become melted or softened, resulting in the separation of the contact portion 162 from the red copper plate 40, such that a gap is formed between the contact portion 162 and the red copper plate 40.

As shown in FIG. 5, in this example, the barrier 15 does not contact with the terminal 12. The edge 151 of the barrier 15 only abuts against the low-temperature soldering material 17 and is held thereby. Under the effect of the spring 154, the barrier 15 is always abutted against the low-temperature soldering material 17. When the soldering material 17 starts to melt or soften, as shown in FIG. 8, the edge 151 moves to push away the soldering material 17 under the elastic force of the spring 154 and locates between the gap formed between the contact portion 162 and the red copper plate 40, so as to cut off any electric arc that is possibly formed in the gap.

As shown in FIGS. 7 and 8, during the movement toward the gap, the barrier 15 is rotated about the pivot 156 so that the edge 151 has a curved movement trajectory. The rotation about the pivot for a certain angle replaces the monolithic translation of the barrier, such that it takes less time for the non-conductive barrier to move into the gap and therefore faster arc distinguishing is achieved. The person skilled in the art will appreciated that, the combination of the extension 155, the pivot 156, the pivot mount 11 and the pivot hole 112 may independently be presented in another embodiment, to achieve faster arc distinguishing.

### Example 2

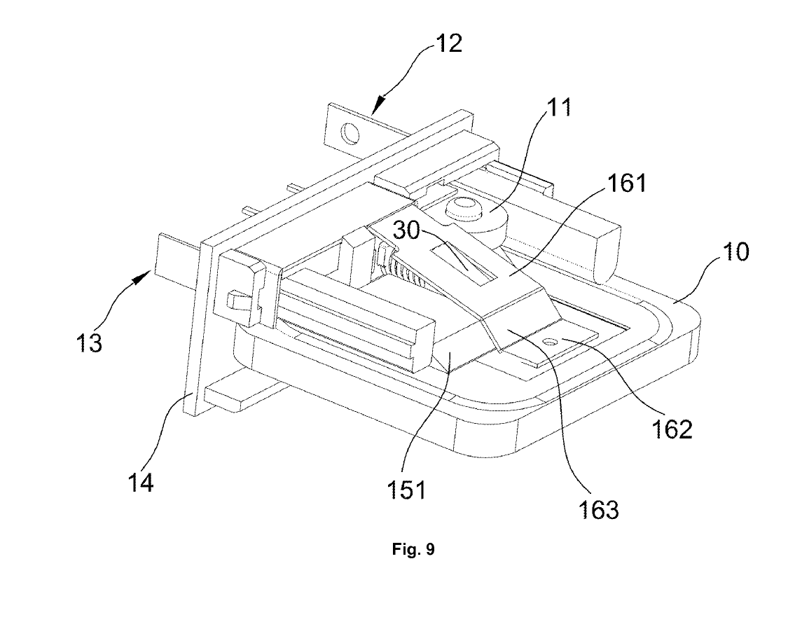

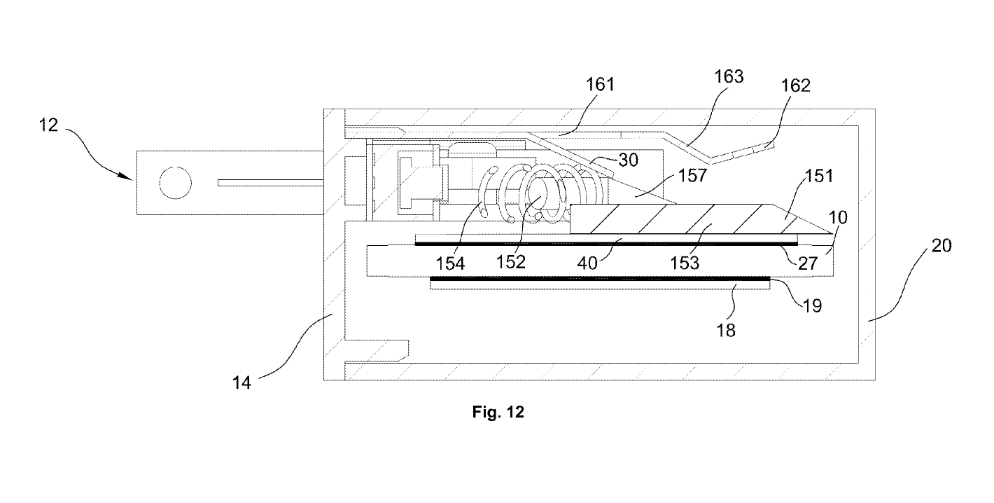

FIGS. 9 through 12 show a surge suppression device according to another embodiment of the invention. FIG. 9 is a perspective view of the surge suppression device which is substantively same with the surge suppression device as shown in FIG. 1 except that a cantilever 30 is provided to the arm portion 161 of the terminal 12. As shown in FIG. 10, in this example, the cantilever 30 is formed by cutting the arm portion 161 with one end integral with the arm portion and the other end in contact with the barrier 15. The cantilever 30 is disposed to apply a certain amount of force to the barrier 15 through the other end. Therefore, when the edge 151 of the barrier 15 is abutted against the low-temperature soldering material 17 or both the low-temperature soldering material 17 and the contact portion 162, due to the force exerted by the cantilever 30 toward the barrier 15, the stress applied to the connections between the contact portion 162, the low-temperature soldering material 17 and the MOV 10 by the barrier 15 is reduced, such that the structural stability of the device is improved. FIGS. 10 and 12 show the sectional view of the housing 20.

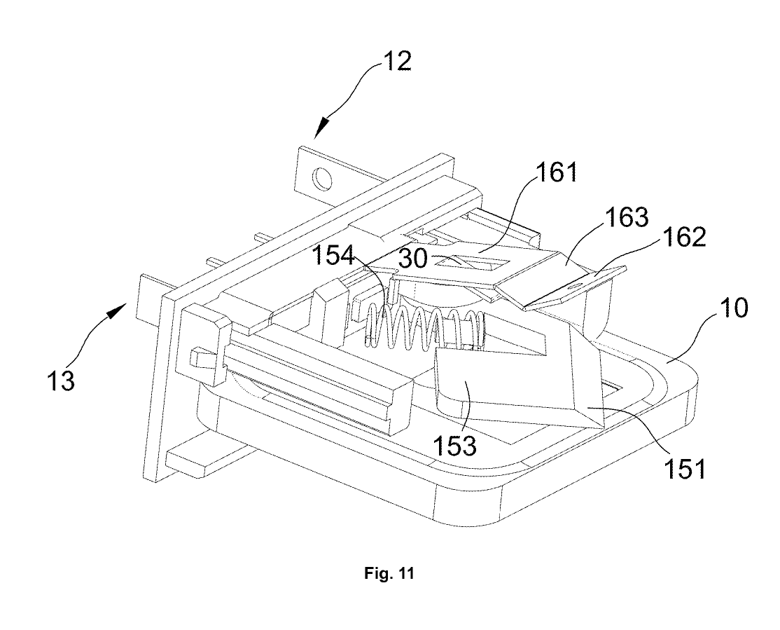

FIGS. 11 and 12 show the perspective and sectional views of the surge suppression device in failed state, respectively. Similarly, when the soldering material 17 starts to melt or soften, the edge 151 moves to push away the soldering material 17 under the elastic force of the spring 154 and locates between the gap formed between the contact portion 162 and the MOV 10, so as to cut off any electric arc that possibly formed in the gap.

In addition, in some embodiments, the cantilever 30 may be disposed to have a counter force such that when the contact portion 162 is separated from the MOV 10, the contact portion 162 may be bounced further away from the MOV to enlarge the gap there between, further decreasing the possibility of arc generation. As an example, as shown in FIG. 11, the cantilever 30 moves along the stopper element 157 onto the spring 154 after the separation of the contact portion 162 from the MOV 10, providing support to the arm portion 161.

Of course, the barrier 15 does not necessarily have the structure as shown in the figures. Barriers having different structures can be envisioned by the person skilled in the art. Therefore, the cantilever 30 can be independently included in an embodiment without in combination with the features of the barrier 15, so as to achieve the arc distinguishing effect expected by the present invention.

### Example 3

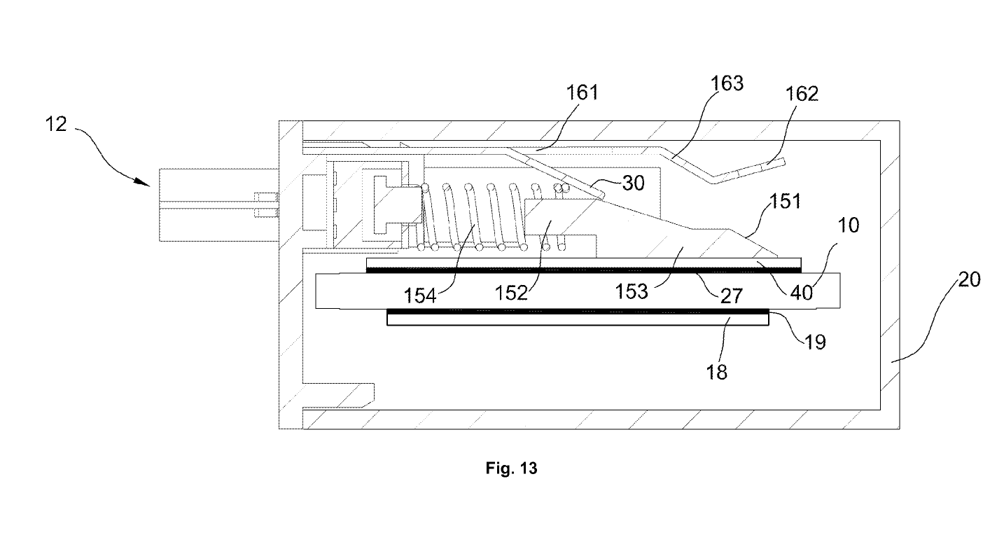

FIG. 13 shows a sectional view of yet another exemplary surge suppression device in failed state. In this example, the surge suppression device does not comprise the extension 155, the pivot 156, the pivot mount 11 and the pivot hole 112 as shown in FIGS. 1 and 2. Therefore, the barrier 15 undergoes translational movement under the effect of the spring 154 along the surface of the MOV 10 toward right direction in the figure when the soldering material 17 starts to melt or soften, and finally locates between the contact portion 162 and the MOV 10. In this case, the edge 151 has a substantively linear movement trajectory.

It should be understood that various embodiments have been described with reference to the accompanying drawings in which only some example embodiments are shown. As described above, the feature or feature combinations in respective embodiment can independently appear or be used with a feature or feature combinations in other embodiments, as long as faster arc distinguishing or stronger structure stability is achieved.

1. A surge suppression device, comprising
a voltage sensitive element having a predetermined voltage rating, said voltage sensitive element increasing in temperature as voltage applied to the voltage sensitive element exceeds said voltage rating;
a first terminal having one end electrically connected to a first surface of said voltage sensitive element;
a second terminal comprising an arm portion and a contact portion, the contact portion being electrically connected to a second surface of the voltage sensitive element, and the second terminal being biased away from the voltage sensitive element;
a non-conductive barrier biased to move from a first position in which said non-conductive barrier allows electrical contact between the second terminal and the voltage sensitive element, to a second position in which the second terminal is not in contact with the voltage sensitive element and the non-conductive barrier is disposed between said second terminal and the voltage sensitive element, wherein
in the first position, a conductive metal plate is disposed between the contact portion and the voltage sensitive element, the contact portion being electrically connected to the conductive metal plate through a first heat sensitive material, the conductive metal plate being electrically connected to the voltage sensitive element through a second heat sensitive material, and wherein
the contact portion, the first heat sensitive material, the conductive metal plate, the second heat sensitive material and the voltage sensitive element are connected substantively in parallel with respect to each other.

2. The surge suppression device of claim 1, wherein the conductive metal plate has a surface area not less than that of the contact portion.

3. The surge suppression device of claim 2, wherein the conductive metal plate has a surface area accounting for from about 20% to about 100%, or about 60% to about 90%, or about 70% to about 80%, of the surface area of the second surface of the voltage sensitive element.

4. The surge suppression device of claim 1, wherein the conductive metal plate is formed of copper or plated copper.

5. The surge suppression device of claim 4, wherein the conductive metal plate is a red copper plate or a tin-plated or silver-plated red copper plate.

6. The surge suppression device of claim 1, wherein the first heat sensitive material has a softening temperature not higher than that of the second heat sensitive material.

7. The surge suppression device of claim 1, wherein the non-conductive barrier has an edge with reduced thickness.

8. The surge suppression device of claim 7, wherein, in the first position, the edge of the non-conductive barrier is abutted against the first heat sensitive material and/or the contact portion.

9. The surge suppression device of claim 1, wherein the voltage sensitive element is a metal oxide varistor (MOV) bare disc having a silver or copper outer layer.

10. The surge suppression device of claim 1, wherein the first and/or second heat sensitive material is a solder metal comprised of a fusible alloy.

11. The surge suppression device of claim 1, wherein the non-conductive barrier is biased toward the second position by an elastic element.

12. The surge suppression device of claim 11, wherein the non-conductive barrier has a stopper element extending from a surface of the barrier, for holding the elastic element.

13. The surge suppression device of claim 12, wherein the stopper element has a guiding portion for receiving the elastic element.

14. The surge suppression device of claim 11, wherein the elastic element is a spring.

15. The surge suppression device of claim 1, wherein the arm portion has a cantilever with a free end of the cantilever oriented toward the non-conductive barrier and applying a force to the non-conductive barrier.

16. The surge suppression device of claim 15, wherein the cantilever is formed by cutting a portion of the arm portion of the second terminal, and the free end of the cantilever is in contact with the non-conductive barrier, an end of the cantilever opposing the free end is integral with the arm portion of the second terminal.

17. The surge suppression device of claim 1, wherein the surge suppression device further comprises a seat having a pivot mount to which a pivot of the non-conductive barrier is mounted, such that the non-conductive barrier can rotate about the pivot.
